(19) United States
(12) Patent Application Publication
(10) Pub. No.: US 2025/0162581 A1
(43) Pub. Date: May 22, 2025

(54) DYNAMIC AND ADAPTIVE AGV SPEED AND DISTANCE

(71) Applicant: GM Global Technology Operations LLC, Detroit, MI (US)

(72) Inventors: Zachary Norman Brunner, Grand Blanc, MI (US); David Peet, Flushing, MI (US)

(73) Assignee: GM Global Technology Operations LLC, Detroit, MI (US)

(21) Appl. No.: 18/513,831

(22) Filed: Nov. 20, 2023

(51) Int. Cl. B60W 30/14; B60W 60/00

(52) U.S. Cl. CPC B60W 30/143; B60W 60/001

(57) ABSTRACT

A method includes, as a vehicle travels at a first speed along a predefined path of travel between a first waypoint and a second waypoint, and based on determining presence of an object within a first portion of a field of sensing of a sensor disposed at the vehicle, adjusting speed of the vehicle from the first speed to a second speed that is less than the first speed. With the vehicle travelling at the first speed, the first portion of the field of sensing extends a first distance from the vehicle. With the vehicle travelling at the second speed along the predefined path of travel, the method includes adjusting the first portion of the field of sensing to extend a second distance from the vehicle that is less than the first distance.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to operation of an automated guided vehicle (AGV) as the AGV travels within an environment, and more specifically to dynamically adjusting the AGV's scanning profile and speed based on the AGV's distance to detected objects.

An AGV typically transports a load within an environment (e.g., an industrial or manufacturing environment) by following predefined paths of travel between stations. The AGV is equipped with a scanner or sensor system that senses a field of sensing forward of the AGV. As the AGV travels between stations, the AGV generally travels at a predefined speed that is limited based on the distance needed for the AGV to come to a stop when an object is detected within the field of sensing. Thus, when the scanner of the AGV detects an object within the field of sensing, the AGV must come to a complete stop to avoid impacting the detected object. Because the speed of the AGV is limited based on the field of sensing, which in turn causes the AGV to come to a complete stop when an object is detected, inefficiencies are created in the travel cycle time of the AGV between stations and the AGV often stops with greater than a minimum clearance between the AGV and the detected object.

To allow the AGV to travel at full speed between stations and come to a complete stop with minimal clearance between the AGV and detected objects, the speed of the AGV is dynamically adjusted as the scanner detects objects within the field of sensing and the field of sensing is dynamically adjusted according to the speed of the AGV.

### SUMMARY

One aspect of the disclosure provides a computer-implemented method executed by data processing hardware that causes the data processing hardware to perform operations. The operations include as a vehicle travels at a first speed along a predefined path of travel between a first waypoint and a second waypoint, and based on determining the presence of an object within a first portion of a field of sensing of a sensor disposed at the vehicle, adjusting a speed of the vehicle from the first speed to a second speed that is less than the first speed. With the vehicle travelling at the first speed, the first portion of the field of sensing extends a first distance from the vehicle. With the vehicle travelling at the second speed along the predefined path of travel, the operations include adjusting the first portion of the field of sensing to extend a second distance from the vehicle that is less than the first distance.

Implementations of the disclosure may include one or more of the following optional features. In some implementations, with the vehicle travelling at the second speed along the predefined path of travel and the first portion of the field of sensing extending the second distance from the vehicle, and based on determining the presence of the object within the first portion of the field of sensing, the operations further include adjusting a speed of the vehicle from the second speed to a third speed that is less than the second speed. With the vehicle travelling at the third speed along the predefined path of travel, the operations further include adjusting the first portion of the field of sensing to extend a third distance from the vehicle that is less than the second distance.

In some examples, with the vehicle travelling at the second speed along the predefined path of travel and the first portion of the field of sensing extending the second distance from the vehicle, and based on determining absence of the object within the first portion of the field of sensing, the operations further include adjusting a speed of the vehicle from the second speed to the first speed. Further, the operations include adjusting the first portion of the field of sensing to extend the first distance from the vehicle.

In some aspects, a second portion of the field of sensing extends between the vehicle and the first portion of the field of sensing. Moreover, based on determining the presence of the object within the second portion of the field of sensing, the operations include stopping the vehicle.

In some implementations, the operations further include receiving an instruction to reduce a speed of the vehicle from the first speed when the vehicle arrives at the second waypoint. Based on determining absence of the object within the first portion of the field of sensing at the second waypoint, the operations further include continuing to operate the vehicle at the first speed as the vehicle travels along the predefined path of travel beyond the second waypoint. In further implementations, the instruction is one selected from the group consisting of (i) transmitted to the vehicle from a wireless transmitter disposed along the predefined path of travel at or near the second waypoint, and (ii) determined based on a distance travelled by the vehicle along the predefined path of travel. Optionally, the vehicle includes an automated guided vehicle (AGV).

Another aspect of the disclosure provides a system including data processing hardware and memory hardware in communication with the data processing hardware. The memory hardware stores instructions executed on the data processing hardware that cause the data processing hardware to perform operations. The operations include as a vehicle travels at a first speed along a predefined path of travel between a first waypoint and a second waypoint, and based on determining the presence of an object within a first portion of a field of sensing of a sensor disposed at the vehicle, adjusting a speed of the vehicle from the first speed to a second speed that is less than the first speed. With the vehicle travelling at the first speed, the first portion of the field of sensing extends a first distance from the vehicle. With the vehicle travelling at the second speed along the predefined path of travel, the operations include adjusting the first portion of the field of sensing to extend a second distance from the vehicle that is less than the first distance. This aspect may include one or more of the following optional features.

In some implementations, with the vehicle travelling at the second speed along the predefined path of travel and the first portion of the field of sensing extending the second distance from the vehicle, and based on determining the presence of the object within the first portion of the field of sensing, the operations further include adjusting a speed of the vehicle from the second speed to a third speed that is less than the second speed. With the vehicle travelling at the third speed along the predefined path of travel, the operations further include adjusting the first portion of the field of sensing to extend a third distance from the vehicle that is less than the second distance.

In some examples, with the vehicle travelling at the second speed along the predefined path of travel and the first portion of the field of sensing extending the second distance from the vehicle, and based on determining absence of the object within the first portion of the field of sensing, the operations further include adjusting a speed of the vehicle from the second speed to the first speed. Further, the operations include adjusting the first portion of the field of sensing to extend the first distance from the vehicle.

In some aspects, a second portion of the field of sensing extends between the vehicle and the first portion of the field of sensing. Moreover, based on determining the presence of the object within the second portion of the field of sensing, the operations include stopping the vehicle.

In some implementations, the operations further include receiving an instruction to reduce a speed of the vehicle from the first speed when the vehicle arrives at the second waypoint. Based on determining absence of the object within the first portion of the field of sensing at the second waypoint, the operations further include continuing to operate the vehicle at the first speed as the vehicle travels along the predefined path of travel beyond the second waypoint. In further implementations, the instruction is one selected from the group consisting of (i) transmitted to the vehicle from a wireless transmitter disposed along the predefined path of travel at or near the second waypoint, and (ii) determined based on a distance travelled by the vehicle along the predefined path of travel. Optionally, the vehicle includes an automated guided vehicle (AGV).

Yet another aspect of the disclosure provides an automated guided vehicle (AGV). The AGV includes a sensor disposed at the AGV and sensing a field of sensing relative to the AGV. The AGV includes data processing hardware and memory hardware in communication with the data processing hardware. The memory hardware stores instructions executed on the data processing hardware that cause the data processing hardware to perform operations. The operations include as the AGV travels at a first speed along a predefined path of travel between a first waypoint and a second waypoint, and based on determining the presence of an object within a first portion of the field of sensing of the sensor, adjusting a speed of the AGV from the first speed to a second speed that is less than the first speed. With the AGV travelling at the first speed, the first portion of the field of sensing extends a first distance from the AGV. With the AGV travelling at the second speed along the predefined path of travel, the operations include adjusting the first portion of the field of sensing to extend a second distance from the AGV that is less than the first distance. This aspect may include one or more of the following optional features.

In some implementations, with the AGV travelling at the second speed along the predefined path of travel and the first portion of the field of sensing extending the second distance from the AGV, and based on determining the presence of the object within the first portion of the field of sensing, the operations further include adjusting a speed of the AGV from the second speed to a third speed that is less than the second speed. With the AGV travelling at the third speed along the predefined path of travel, the operations further include adjusting the first portion of the field of sensing to extend a third distance from the AGV that is less than the second distance.

In some examples, with the AGV travelling at the second speed along the predefined path of travel and the first portion of the field of sensing extending the second distance from the AGV, and based on determining absence of the object within the first portion of the field of sensing, the operations further include adjusting a speed of the AGV from the second speed to the first speed. Further, the operations include adjusting the first portion of the field of sensing to extend the first distance from the AGV.

In some aspects, a second portion of the field of sensing extends between the AGV and the first portion of the field of sensing. Moreover, based on determining the presence of the object within the second portion of the field of sensing, the operations include stopping the AGV.

In some implementations, the operations further include receiving an instruction to reduce a speed of the AGV from the first speed when the AGV arrives at the second waypoint. Based on determining absence of the object within the first portion of the field of sensing at the second waypoint, the operations further include continuing to operate the AGV at the first speed as the AGV travels along the predefined path of travel beyond the second waypoint. In further implementations, the instruction is one selected from the group consisting of (i) transmitted to the AGV from a wireless transmitter disposed along the predefined path of travel at or near the second waypoint, and (ii) determined based on a distance travelled by the AGV along the predefined path of travel.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of a vehicle travelling along a path of travel.

FIG. 2 is a schematic view of a control module of the vehicle.

FIGS. 3A-3C are schematic views of the vehicle and fields of sensing of a sensor of the vehicle at different speeds of travel of the vehicle.

FIG. 4 is a flowchart of an example method for dynamically adjusting a speed of travel of the vehicle and the field of sensing of the sensor as the vehicle travels along a path.

FIG. 5 is a flowchart of another example method for dynamically adjusting a speed of travel of the vehicle and the field of sensing of the sensor as the vehicle travels along a path.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

An automated guided vehicle (AGV) typically travels within an environment, such as an industrial or manufacturing environment, along predefined paths of travel. The AGV is equipped with a scanner or sensor that senses a field of sensing forward of the AGV. The field of sensing extends a depth or distance from the AGV and the speed of the AGV is limited based on the depth of the field of sensing and the AGV's ability to stop before impacting an object detected in the field of sensing. In other words, the AGV's speed is limited so that when an object is detected in the field of sensing, the AGV is able to stop before impacting the object. In some examples, the AGV must maintain a threshold clearance between the AGV and the detected object once the AGV is stopped, such that the speed of the AGV is limited based on the depth of the field of sensing and the threshold clearance.

Thus, when the AGV is travelling within the environment, the AGV commonly travels at the speed limited by the depth of the field of sensing and/or the threshold clearance distance, such that when an object is detected in the field of sensing, the AGV comes to a complete stop to avoid impacting the detected object. However, because the speed of the AGV is limited based on the stopping distance and depth of the field of sensing, travel time between destinations is increased. Typically, AGVs are equipped with simple sensors or scanners where the depth of the field of sensing is fixed based on capabilities of the sensor or may only be adjusted when the AGV is stopped, thus leading to inefficiencies during travel of the AGV. Moreover, objects often move in and out of the field of sensing of the AGV, such that it is not always necessary for the AGV to come to a complete stop to avoid impacting the object. Further, based on differences between the AGV's assumed or predicted stopping distance and the AGV's actual stopping distance, the AGV generally comes to a complete stop at a distance further from the detected object than the threshold clearance, which can lead to a longer lineup of AGVs than necessary.

As discussed further below, the present disclosure allows the sensor or scanner to sense or detect objects at a distance in front of the AGV that does not require the AGV to initiate an immediate stop to avoid impacting the detected object. Instead, when an object is detected in the field of sensing, the speed of the AGV is reduced to a non-zero speed. Once the AGV reaches the reduced speed, the depth of the field of sensing of the sensor or scanner is reduced according to the reduced speed. If the object is detected in the reduced field of sensing, the speed of the AGV is again reduced, and the depth of the field of sensing of the sensor or scanner is reduced according to this new reduced speed. This process may be repeated until the AGV comes to a complete stop or the detected object is near enough to the AGV that the AGV must come to a complete stop to avoid impacting the detected object. Although discussed herein as relating to an AGV travelling along a predefined path, it should be understood that the system and methods discussed herein are applicable to any suitable vehicle equipped with a sensor for detecting objects within a path of travel of the vehicle, such as an automated guided cart (AGC), an autonomous mobile robot (AMR), a passenger vehicle, and the like.

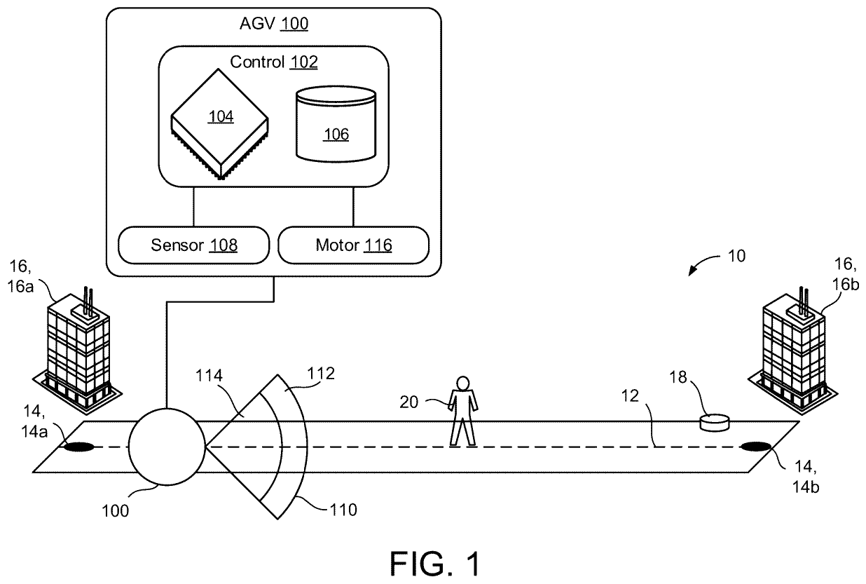

Referring now to the figures and the illustrated configurations depicted therein, a vehicle or automated guided vehicle (AGV) 100 travels within an environment 10, such as an industrial or manufacturing environment like a factory or warehouse (FIG. 1). In the illustrated example, the AGV 100 travels along a predefined path of travel 12 between waypoints 14, 14a-b associated with corresponding features or locations 16, 16a-b in the environment 10. For example, the AGV 100 may transport supplies from a storage area and/or transport a load between workstations within the environment 10.

The AGV 100 includes a control module 102, such as a programmable logic controller (PLC), having data processing hardware 104 and memory hardware 106 in communication with the data processing hardware 104. The memory hardware 106 stores instructions that, when executed on the data processing hardware 104, cause the data processing hardware 104 to perform operations. For example, the memory hardware 106 stores instructions for controlling operation of the AGV 100 as the AGV 100 travels along the path of travel 12 and for dynamically adjusting a speed of the AGV 100 based on a sensor or scanner 108 at the AGV 100 detecting the presence of an object 20 within a field of sensing 110 of the sensor 108.

The sensor 108, such as a ladar sensor, lidar sensor, radar sensor, camera, and the like, senses the field of sensing or scanning profile 110 in front of the AGV 100 to detect static and moving obstacles 20, such as people, other AGVs, objects, checkpoints, and the like, along the path of travel 12 of the AGV 100. The field of sensing 110 includes a first portion or warning zone 112 extending a first distance from the AGV 100 and a second portion or stop zone 114 extending between the AGV 100 and the warning zone 112.

The distance or depth of the first portion 112 and the second portion 114 from the AGV 100 (e.g., the distance that the respective portion of the field of sensing 110 extends horizontally along a direction of travel from the AGV 100) may be based on the stopping distance of the AGV 100 at the current speed. Thus, when the object 20 is detected within the stop zone 114, the control module 102 brings the AGV 100 to a complete stop to avoid impacting the object 20. As discussed further below, the warning zone 112 extends a further distance from the AGV 100 than the stop zone 112 and, thus, when the object 20 is detected within the warning zone 112, the control module 102 adjusts operation of a motor 116 of the AGV 100 to reduce a speed of the AGV 100 and therefore reduce the stopping distance of the AGV 100.

With the speed of the AGV 100 reduced after detecting the presence of the object 20 within the warning zone 112, the control module 102 reduces a depth of the warning zone 112 and/or the stop zone 114 according to the reduced speed of the AGV 100. Put another way, the distance or depth of the first portion 112 and/or the second portion 114 from the AGV 100 is dynamically adjustable based on a current speed of travel of the AGV 100.

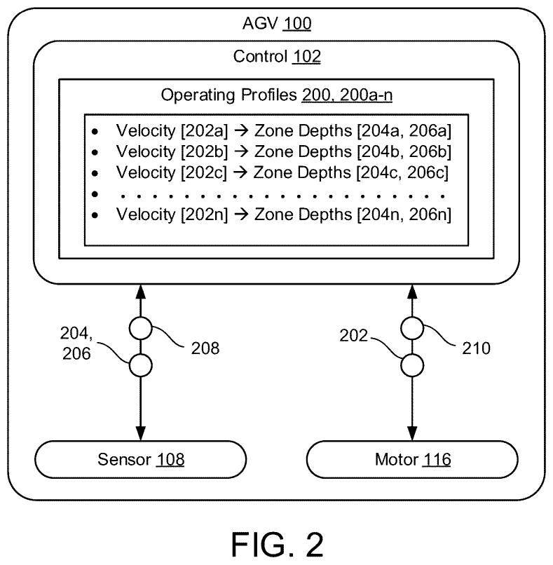

As shown in FIG. 2, the control module 102 maintains operating profiles 200, 200a-n for the AGV 100 that delineate target velocities or speeds of travel 202, 202a-n for the AGV 100 and depths or distances 204, 204a-n of the warning zone 112 and depths or distances 206, 206a-n of the stop zone 114 corresponding to the speeds of travel 202. For each speed of travel 202, the corresponding depth 206 of the stop zone 114 is based on stopping distance for the AGV 100 to avoid impact with an object 20 detected within the stop zone 114 and the corresponding depth 204 of the warning zone 112 is set so that the sensor 108 detects the object 20 before the AGV 100 needs to stop to avoid impact with the detected object 20.

When the object 20 is detected in the warning zone 112 of one operating profile 200, such as determined based on captured sensor data or a signal 208 transmitted from the sensor 108 indicating the presence of the object 20 in the warning zone 112, the control module 102 adjusts operation of the motor 116 to achieve the target velocity 202 of the next operating profile 200, thus reducing the speed of the AGV 100. Once the AGV 100 achieves the reduced target velocity 202, such as determined based on a signal 210 from the motor 116 indicating that the AGV 100 is travelling at the target velocity 202, the control module 102 adjusts depth 204 of the warning zone 112 and/or depth 206 of the stop zone 114 based on the operating profile 200 corresponding to the target velocity 202.

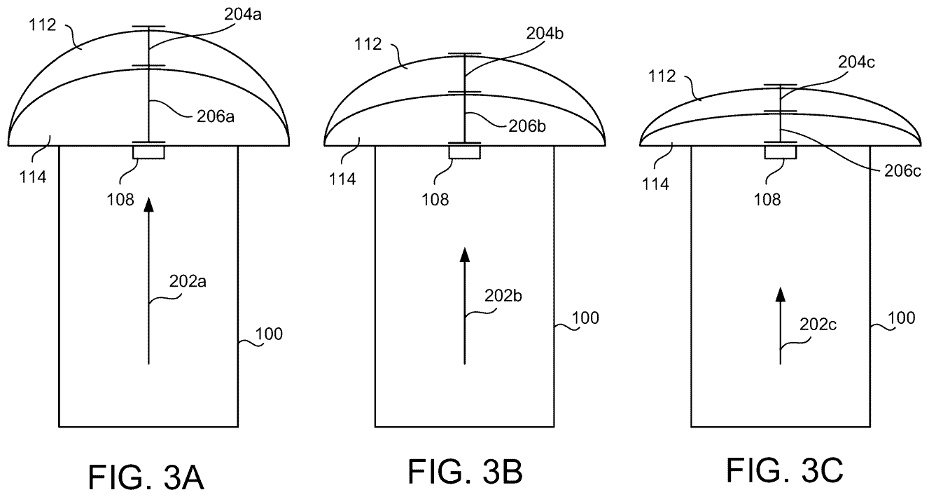

For example, and with reference to FIGS. 1, 2, and 3A-3C, as the AGV 100 travels at a first speed 202, 202a along the path of travel 12, such as between a first waypoint 14, 14a corresponding to a first location 16, 16a within the environment 10 and a second waypoint 14, 14b corresponding to a second location 16, 16b within the environment 10, the first portion 112 of the field of sensing 110 extends a corresponding first distance 204, 204a from the AGV 100 and the second portion 114 of the field of sensing 110 extends a corresponding first distance 206, 206a between the AGV 100 and the first portion 112. Based on determining the presence of the object 20 within the first portion 112 of the field of sensing 110, the control module 102 adjusts a speed 202 of the AGV 100 from the first speed 202a to a second speed 202, 202b that is less than the first speed 202a. With the AGV 100 travelling at the second speed 202b, the control module 102 adjusts the first portion 112 of the field of sensing 110 to extend a corresponding second distance 204, 204b from the AGV 100 that is less than the first distance 204a. Further, the control module 102 may adjust the second portion 114 of the field of sensing 110 to extend a corresponding second distance 206, 206b between the AGV 100 and the first portion 112.

With the AGV 100 travelling at the second speed 202b, and based on determining the presence of the object 20 within the first portion 112 of the field of sensing 110, the control module 102 adjusts a speed 202 of the AGV 100 to a third speed 202, 202c that is less than the second speed 202b. With the AGV 100 travelling at the third speed 202c, the control module 102 adjusts the first portion 112 of the field of sensing 110 to extend a corresponding third distance 204, 204c from the AGV 100 that is less than the second distance 204b. The control module 102 may adjust the second portion 114 of the field of sensing 110 to extend a corresponding third distance 206, 206c between the AGV 100 and the first portion 112.

The process of detecting the object 20 within the warning zone 112, slowing the AGV 100, and reducing the distance 204 of the warning zone 112 from the AGV 100 repeats until the sensor 108 no longer detects the object 20 or until the AGV 100 is slowed to a stop. For example, the control module 102 may maintain a finite number of operating profiles 200 (e.g., 32 operating profiles with corresponding velocities and zone depths). Optionally, each operating profile 200 acts as a gate, where the target velocities 202 must be achieved in successive order until the AGV 100 is slowed to a stop or the object 20 is detected within the stop zone 114 and the AGV 100 is stopped.

When the AGV 100 is travelling at a reduced speed 202 and the control module 102 determines that the object 20 is no longer an impact concern, the control module 102 adjusts operation of the motor 116 to increase speed of the AGV 100 and the control module 102 adjusts the field of sensing 110 to increase the corresponding depth 204 of the first portion 112 and the corresponding depth 206 of the second portion 114. For example, the control module 102 determines that the object 20 is not an impact concern when the object 20 has not been detected in the field of sensing 110 for a threshold period of time (e.g., 5 seconds or more, 10 seconds or more, 30 seconds or more, and the like). Thus, the control module 102 increases a speed of the AGV 100 when the object 20 moves out of the path of travel 12.

For example, when the AGV 100 is travelling at the second speed 202b with the first portion 112 of the field of sensing 110 extending the second distance 204b from the AGV 100, and based on determining absence of the object 20 within the first portion 112 and the second portion 114 of the field of sensing 110, the control module 102 adjusts the first portion 112 of the field of sensing 110 to extend the corresponding first distance 204a from the AGV 100 and adjusts the speed 202 of the AGV 100 from the second speed 202b to the first speed 202a. The control module 102 may further adjust the second portion 114 of the field of sensing 110 from extending the corresponding second distance 206b to extending the corresponding first distance 206a between the AGV 100 and the first portion 112.

Thus, the control module 102 dynamically adjusts speed 202 of the AGV 100 based on detection of objects 20 within the first portion or warning zone 112 of the field of sensing 110 so that the AGV 100 may be slowed down when the object 20 is detected rather than brought to a complete stop. This reduces travel time of the AGV 100 along the path of travel 12 as the AGV 100 is not brought to a complete stop each time an object 20 is detected. Further, the AGV 100 may travel along the path of travel 12 at its maximum speed of travel as the sensor 108 will detect objects 20 ahead of the stopping distance required by the second portion 114 of the field of sensing 110, as when the object 20 is detected in the second portion 114, the AGV 100 is brought to a stop. Moreover, because the speed 202 of the AGV 100 is reduced until the object 20 is within the second portion 114 of the field of sensing 114, the AGV 100 is brought to a stop much closer to the object 20 than if the AGV 100 were immediately brought to a stop upon first detection of the object 20.

For example, the detected object 20 is a lineup of other AGVs, where it is desirable to stack or position the AGVs with a minimum clearance between adjacent AGVs, such as about 20 inches or less. Because the control module 102 gradually slows the AGV 100 as it approaches the detected object 20, the AGV 100 stops with the minimum clearance distance between the equipped AGV and the detected AGV 20. This reduces space required for a lineup of AGVs within the environment 10.

In some examples, the path of travel 12 between waypoints 14 and corresponding locations 16 is set in the environment 10, such as via guide tape tracked by a guide sensor at the AGV 100. Optionally, the path of travel 12 is stored in memory 106 at the AGV 100 and the control module 102 may track a position of the AGV 100 along the path of travel 12 based on signals from a motor encoder at the motor 116.

Based on the position of the AGV 100 along the path of travel 12, the control module 102 may be instructed to adjust speed 202 of the AGV 100, such as if the position along the path of travel 12 corresponds to an area of high traffic or a waiting area where the AGV 100 typically slows down or stops to wait for other AGVs to cycle through an upcoming waypoint 14. To avoid unnecessary stoppages, the control module 102 may overrule or override instructions to slow down or stop at these positions along the path of travel 12 based on determination that no object 20 is within the field of sensing 110 when the AGV 100 arrives at these positions.

In the illustrated example of FIG. 1, the control module 102 has an instruction to reduce speed 202 of the AGV 100, such as to reduce speed 202 from the first speed 202a, as the AGV 100 approaches the second waypoint 14b. For example, the instruction is transmitted to the AGV 100 from a wireless transmitter, such as a radio frequency identification (RFID) tag or puck 18, disposed along the path of travel 12 at or near the second waypoint 14b. Optionally, the instruction is determined based on a distance travelled by the AGV 100 along the path of travel 12. Based on determining absence of the object 20 within the first portion 112 of the field of sensing 110 and within the second portion 114 of the field of sensing 110 at the second waypoint 14b, the control module 102 continues to operate the AGV 100 at the first speed 202a as the AGV 100 travels along the path of travel 12 to and/or beyond the second waypoint 14b.

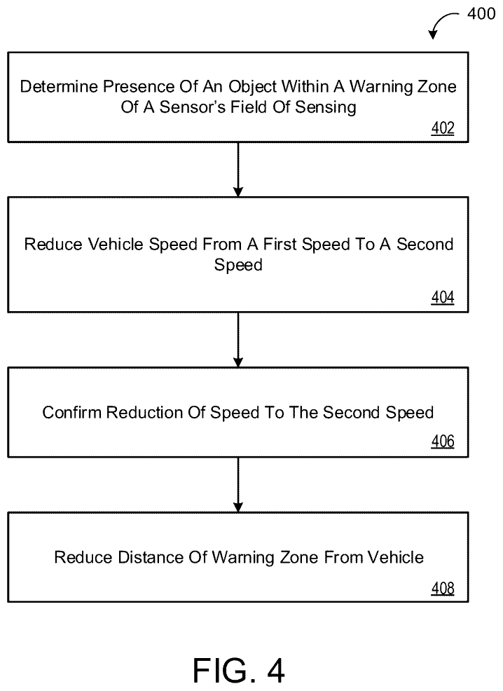

FIG. 4 provides a flowchart for an example method 400 for dynamically adjusting speed 202 of the AGV 100 and depth of the field of sensing 110 of the sensor 108 at the AGV 100 as the AGV 100 travels along a path of travel 12 between the first waypoint 14a and the second waypoint 14b and detects an object 20 within the first portion 112 of the field of sensing 110. The control module 102 may perform operations for the method 400. At operation 402, the method 400 includes determining the presence of the object 20 within the first portion 112 of the field of sensing 110 of the sensor 108 at the AGV 100. At operation 404, the method 400 includes adjusting speed 202 of the AGV 100 from the first speed 202a to the second speed 202b that is less than the first speed 202a. At operation 406, the method 400 includes confirming that the AGV 100 is travelling at the reduced second speed 202b, such as via signal 210 from the motor 116. At operation 408, and with the AGV 100 travelling at the reduced second speed 202b, the method 400 includes adjusting the first portion 112 of the field of sensing 110 to extend the second distance 204b that is less than the first distance 204a.

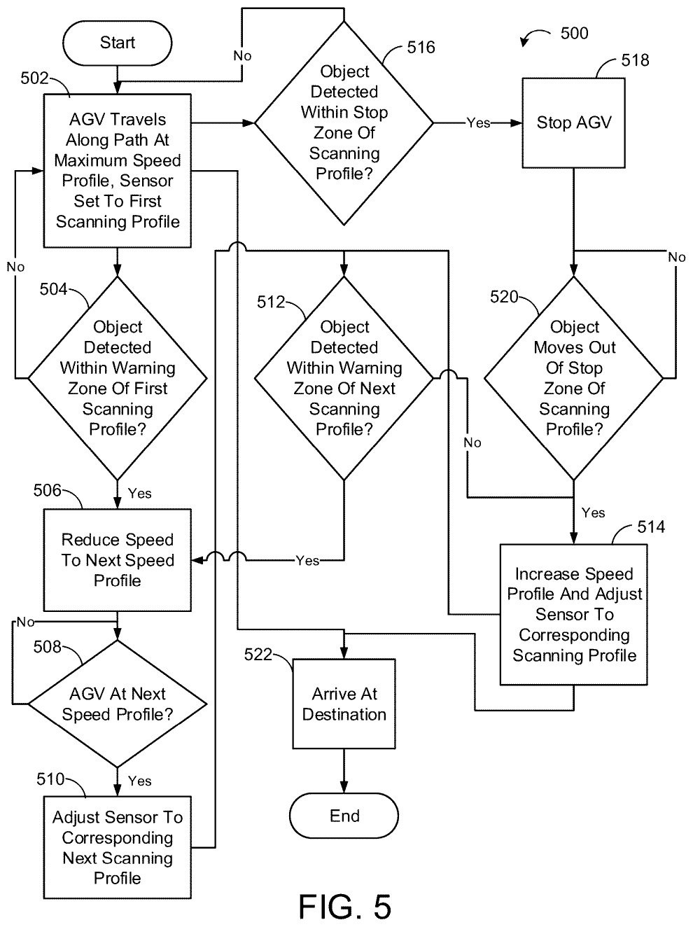

FIG. 5 provides a flowchart for another example method 500 for dynamically adjusting speed 202 of the AGV 100 and depth of the field of sensing 110 of the sensor 108 at the AGV 100 as the AGV 100 travels along a path of travel 12 and detects an object 20 within the first portion 112 of the field of sensing 110. The control module 102 may perform operations for the method 500. At operation 502, the method 500 includes controlling operation of the AGV 100 along the path of travel 12 at the maximum first speed 202a. With the AGV 100 travelling at the first speed 202a, the first portion 112 of the field of sensing 110 extends the first distance 204a from the AGV 100. At operation 504, the method 500 includes determining whether the object 20 has been detected within the first portion 112 of the field of sensing 110. If the object 20 has not been detected within the first portion 112 of the field of sensing 110, the method 500 returns to operation 502. If the object 20 has been detected within the first portion 112 of the field of sensing 110, the method 500 at operation 506 adjusts speed 202 of the AGV 100 from the first speed 202a to the second speed 202b of the next operating profile 200 that is less than the first speed 202a. At operation 508, the method 500 includes determining whether the AGV 100 is travelling at the second speed 202b. Once the AGV 100 is travelling at the second speed 202b, the method 500 at operation 510 includes adjusting the first portion 112 of the field of sensing 110 to extend the second distance 204b of the next operating profile 200 that is less than the first distance 204a.

At operation 512, the method 500 includes determining whether the object 20 is detected within the first portion 112 of the field of sensing 110 set at the second distance 204b. If the object 20 has been detected within the first portion 112 of the field of sensing 110 at operation 512, the method 500 returns to operation 506 until the AGV 100 arrives at its destination (operation 522). If the object 20 has not been detected within the first portion 112 of the field of sensing 110 at operation 512, the method 500 at operation 514 includes increasing the speed 202 of the AGV and adjusting the distance 204 of the first portion 112 of the field of sensing 110 to the next operating parameter 200 until the AGV 100 arrives at its destination (operation 522).

At operation 516, the method 500 includes determining whether the object 20 is detected within the second portion 114 of the field of sensing 110. If the object 20 has not been detected within the second portion 114 of the field of sensing 110 at operation 516, the method 500 returns to operation 502. If the object 20 has been detected within the second portion 114 of the field of sensing 110 at operation 516, the method 500 at operation 518 includes stopping the AGV 100. At operation 520, the method 500 includes determining whether the object 20 has moved out of the second portion 114 of the field of sensing 110. Once the object 20 has moved out of the second portion 114 of the field of sensing 110, the method 500 proceeds to operation 514 until the AGV 100 arrives at its destination (operation 522).

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method executed by data processing hardware that causes the data processing hardware to perform operations comprising:
as a vehicle travels at a first speed along a predefined path of travel between a first waypoint and a second waypoint, and based on determining presence of an object within a first portion of a field of sensing of a sensor disposed at the vehicle, adjusting speed of the vehicle from the first speed to a second speed that is less than the first speed, wherein, with the vehicle travelling at the first speed, the first portion of the field of sensing extends a first distance from the vehicle; and
with the vehicle travelling at the second speed along the predefined path of travel, adjusting the first portion of the field of sensing to extend a second distance from the vehicle that is less than the first distance.

2. The method of claim 1, wherein the operations further comprise:
with the vehicle travelling at the second speed along the predefined path of travel and the first portion of the field of sensing extending the second distance from the vehicle, and based on determining presence of the object within the first portion of the field of sensing, adjusting speed of the vehicle from the second speed to a third speed that is less than the second speed; and
with the vehicle travelling at the third speed along the predefined path of travel, adjusting the first portion of the field of sensing to extend a third distance from the vehicle that is less than the second distance.

3. The method of claim 1, wherein the operations further comprise, with the vehicle travelling at the second speed along the predefined path of travel and the first portion of the field of sensing extending the second distance from the vehicle, and based on determining absence of the object within the first portion of the field of sensing:
adjusting speed of the vehicle from the second speed to the first speed; and
adjusting the first portion of the field of sensing to extend the first distance from the vehicle.

4. The method of claim 1, wherein:
a second portion of the field of sensing extends between the vehicle and the first portion of the field of sensing; and
the operations further comprise, based on determining presence of the object within the second portion of the field of sensing, stopping the vehicle.

5. The method of claim 1, wherein the operations further comprise:
receiving an instruction to reduce speed of the vehicle from the first speed when the vehicle arrives at the second waypoint; and
based on determining absence of the object within the first portion of the field of sensing at the second waypoint, continuing to operate the vehicle at the first speed as the vehicle travels along the predefined path of travel beyond the second waypoint.

6. The method of claim 5, wherein the instruction is one selected from the group consisting of:
transmitted to the vehicle from a wireless transmitter disposed along the predefined path of travel at or near the second waypoint; and
determined based on a distance travelled by the vehicle along the predefined path of travel.

7. The method of claim 1, wherein the vehicle comprises an automated guided vehicle (AGV).

8. A system, the system comprising:
data processing hardware; and
memory hardware in communication with the data processing hardware, the memory hardware storing instructions executed on the data processing hardware that cause the data processing hardware to perform operations comprising:
as a vehicle travels at a first speed along a predefined path of travel between a first waypoint and a second waypoint, and based on determining presence of an object within a first portion of a field of sensing of a sensor disposed at the vehicle, adjusting speed of the vehicle from the first speed to a second speed that is less than the first speed, wherein, with the vehicle travelling at the first speed, the first portion of the field of sensing extends a first distance from the vehicle; and
with the vehicle travelling at the second speed along the predefined path of travel, adjusting the first portion of the field of sensing to extend a second distance from the vehicle that is less than the first distance.

9. The system of claim 8, wherein the operations further comprise:
with the vehicle travelling at the second speed along the predefined path of travel and the first portion of the field of sensing extending the second distance from the vehicle, and based on determining presence of the object within the first portion of the field of sensing, adjusting speed of the vehicle from the second speed to a third speed that is less than the second speed; and
with the vehicle travelling at the third speed along the predefined path of travel, adjusting the first portion of the field of sensing to extend a third distance from the vehicle that is less than the second distance.

10. The system of claim 8, wherein the operations further comprise, with the vehicle travelling at the second speed along the predefined path of travel and the first portion of the field of sensing extending the second distance from the vehicle, and based on determining absence of the object within the first portion of the field of sensing:
adjusting speed of the vehicle from the second speed to the first speed; and
adjusting the first portion of the field of sensing to extend the first distance from the vehicle.

11. The system of claim 8, wherein:
a second portion of the field of sensing extends between the vehicle and the first portion of the field of sensing; and
the operations further comprise, based on determining presence of the object within the second portion of the field of sensing, stopping the vehicle.

12. The system of claim 8, wherein the operations further comprise:
receiving an instruction to reduce speed of the vehicle from the first speed when the vehicle arrives at the second waypoint; and
based on determining absence of the object within the first portion of the field of sensing at the second waypoint, continuing to operate the vehicle at the first speed as the vehicle travels along the predefined path of travel beyond the second waypoint.

13. The system of claim 12, wherein the instruction is one selected from the group consisting of:
transmitted to the vehicle from a wireless transmitter disposed along the predefined path of travel at or near the second waypoint; and
determined based on a distance travelled by the vehicle along the predefined path of travel.

14. The system of claim 8, wherein the vehicle comprises an automated guided vehicle (AGV).

15. An automated guided vehicle (AGV), the AGV comprising:
a sensor disposed at the AGV and sensing a field of sensing relative to the AGV;
data processing hardware; and
memory hardware in communication with the data processing hardware, the memory hardware storing instructions executed on the data processing hardware that cause the data processing hardware to perform operations comprising:
as the AGV travels at a first speed along a predefined path of travel between a first waypoint and a second waypoint, and based on determining presence of an object within a first portion of the field of sensing of the sensor, adjusting speed of the AGV from the first speed to a second speed that is less than the first speed, wherein, with the AGV travelling at the first speed, the first portion of the field of sensing extends a first distance from the AGV; and
with the AGV travelling at the second speed along the predefined path of travel, adjusting the first portion of the field of sensing to extend a second distance from the AGV that is less than the first distance.

16. The AGV of claim 15, wherein the operations further comprise:
with the AGV travelling at the second speed along the predefined path of travel and the first portion of the field of sensing extending the second distance from the AGV, and based on determining presence of the object within the first portion of the field of sensing, adjusting speed of the AGV from the second speed to a third speed that is less than the second speed; and
with the AGV travelling at the third speed along the predefined path of travel, adjusting the first portion of the field of sensing to extend a third distance from the AGV that is less than the second distance.

17. The AGV of claim 15, wherein the operations further comprise, with the AGV travelling at the second speed along the predefined path of travel and the first portion of the field of sensing extending the second distance from the AGV, and based on determining absence of the object within the first portion of the field of sensing:
adjusting speed of the AGV from the second speed to the first speed; and
adjusting the first portion of the field of sensing to extend the first distance from the AGV.

18. The AGV of claim 15, wherein:
a second portion of the field of sensing extends between the AGV and the first portion of the field of sensing; and
the operations further comprise, based on determining presence of the object within the second portion of the field of sensing, stopping the AGV.

19. The AGV of claim 15, wherein the operations further comprise:
receiving an instruction to reduce speed of the AGV from the first speed when the AGV arrives at the second waypoint; and
based on determining absence of the object within the first portion of the field of sensing at the second waypoint, continuing to operate the AGV at the first speed as the AGV travels along the predefined path of travel beyond the second waypoint.

20. The AGV of claim 19, wherein the instruction is one selected from the group consisting of:
transmitted to the AGV from a wireless transmitter disposed along the predefined path of travel at or near the second waypoint; and
determined based on a distance travelled by the AGV along the predefined path of travel.
